(19) United States
(12) Patent Application Publication
(10) Pub. No.: US 2019/0042983 A1
(43) Pub. Date: Feb. 7, 2019

(54) System And Method For Planning, Booking And/Or Sharing A Travel Itinerary

(71) Applicant: JPMorgan Chase Bank, N.A., New York, NY (US)

(72) Inventor: Manning R. Field, Media, PA (US)

(73) Assignee: JPMorgan Chase Bank, N.A., New York, NY (US)

(21) Appl. No.: 13/795,306

(22) Filed: Mar. 12, 2013

(51) Int. Cl. G06Q 10/02

(52) U.S. Cl. CPC G06Q 10/02; H04L 63/083

(57) ABSTRACT

Systems and methods for planning, booking and/or sharing a travel itinerary are disclosed. The system may comprise processor that is programmed to: (1) receive content from a financial institution which may include a number of points accumulated by a cardholder; a recommendation as to at least one item on a travel itinerary; and a number of points required to purchase at least one item on a travel itinerary; (2) generate a web page that may include a visual depiction of at least one travel destination and the number of points accumulated by the cardholder; (3) transmit the webpage to the cardholder; and (4) receive from the cardholder a request to book at least one item on the travel itinerary using the points.

### FIELD OF THE INVENTION

The present invention relates generally to a travel planning system and method, and more particularly to a computer-implemented system and method for providing timely, useful information to a user to enhance the process of planning, booking, and/or sharing a travel itinerary.

### BACKGROUND

There are various web-based travel planning systems that allow a user to book and/or share a travel itinerary. However, the existing systems have limitations in some significant respects. For example, existing systems do not assist the user in understanding how he or she can use rewards points, with or without cash, from a credit card to pay for various parts of the trip. In addition, users may generally perceive that itineraries suggested by a travel company are not customized for their preferences. Also, many existing travel planning systems do not take advantage of relevant information that may be available from various sources, such as social networks. Exemplary embodiments of the present invention address these and other drawbacks of existing systems.

### SUMMARY

According to one embodiment, the invention relates to a travel system comprising a memory; and a processor, wherein the processor is programmed to: receive content from a financial institution, wherein the content includes (a) a number of points accumulated by a cardholder of the financial institution, (b) a recommendation, based on data from other cardholders of the financial institution, as to at least one item on a travel itinerary and (c) a number of points required to purchase at least one item on a travel itinerary; generate a web page that includes (1) a visual depiction of at least one travel destination, (2) the number of points accumulated by the cardholder, (3) a function that visually depicts at least one of: a number of points available to the cardholder, or a number of points required to purchase an element in the travel itinerary, when the cardholder moves a pointer to the item, and (4) an indication that at least one item of the travel itinerary is recommended by other cardholders of the financial institution; transmit the webpage to the cardholder; and receive from the cardholder a request to book at least one item on the travel itinerary using the points.

According to another embodiment, the invention relates to a method comprising receiving a request from a user to provide a web page; receiving web page content from a financial institution, wherein the web page content comprises a login screen for the financial institution; receiving information from the financial institution indicating whether the user has provided valid login credentials; receiving web page content from the financial institution, wherein the web page content comprises a number of points of a user and a number of points for one or more items of a travel itinerary; providing web page content to the user comprising a plurality of travel itineraries, an indication of a number of points associated with the financial institution that the user has accumulated, and a program that displays a number of points required to purchase at least one item on the travel itinerary when the user moves a pointer to the item.

According to another embodiment, the invention relates to a method comprising providing web page content comprising a login screen for a financial institution to a travel system; receiving login credentials from a user; providing an indication to the travel system as to whether the login credentials are valid; and providing web page content to the travel system, wherein the web page content comprises a number of points accumulated by the user and a number of points for at least one item of a travel itinerary.

### BRIEF DESCRIPTION OF THE DRAWINGS

In order to facilitate a fuller understanding of the present invention, reference is now made to the attached drawings. These drawings should not be construed as limiting the present invention, but are intended only to be examples of embodiments of the invention.

FIG. 1 is a diagram of a system according to an exemplary embodiment of the invention;

FIG. 2 is web page of a financial institution according to an exemplary embodiment of the invention;

FIGS. 3-15 are examples of web pages generated and maintained by a travel system according to exemplary embodiments of the invention;

FIG. 16 is an example of an email message sent by a financial institution to a card holder according to an exemplary embodiment of the invention;

FIG. 17 is an example of a website of the financial institution providing access to images related to credit card transactions completed by a cardholder;

FIG. 18 is an example of a social network website that includes images from the financial institution; and

FIG. 19 is an example of a process flow for providing information to a third party according to an exemplary embodiment of the invention.

### DETAILED DESCRIPTION OF EXEMPLARY EMBODIMENTS OF THE INVENTION

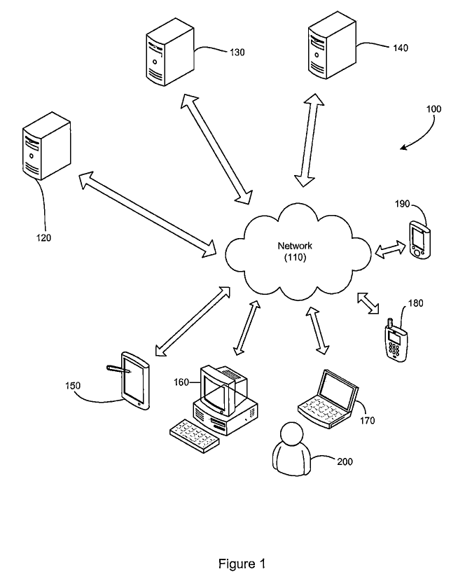

FIG. 1 shows a system according to an exemplary embodiment of the invention. The system comprises a server 100. The server 100 may be owned and/or operated by a financial institution, such as a bank that issues credit cards, debit cards, and other accounts, for example. The server 100 may comprise one or more computer processors, one or more memories and/or storage devices for storing data and computer programs, and associated hardware for communications over a network. The server 100 includes software or computer programs stored on the memory (e.g., a computer readable medium containing program code instructions executed by the processor) for executing the methods described herein. The memory associated with the server 100 may comprise a hard disc, optical disk, a magnetic tape, RAM, a ROM, a PROM, and/or a EPROM, for example. The memory or memories used in the server 100 that implements the invention may be in any of a wide variety of forms to allow the memory to hold instructions, software, data, or other information, as desired. The server 100 shown in FIG. 1 may include one or more types of servers. For example, the server 100 may include a web server that stores, generates and transmits web pages, and it may also include a financial institution processing system that stores and processes account data for various customers of the financial institution, e.g., credit card account data.

The server 100 is connected to a network 110, which may be the Internet, a LAN, Intranet, Extranet, Ethernet, or other communication network, for example. The server 100 can communicate with a number of different communication devices through the network 110. For example, the server 100 can communicate with various devices used by a customer 190 of the bank, such as a tablet computer 140 (e.g., an Apple iPad™ or Samsung Galaxy™), desktop computer 150, laptop computer 160, smart phone 170, e-reader 180 (e.g., an Amazon Kindle™ e-reader), or other computing device. The server 100 can also communicate with other servers, such as a server 120 owned and/or operated by a third party, such as travel company (e.g., Trippy), or a server 130 owned and/or operated by a third party, such as a social network company (e.g., Facebook). The servers 120 and 130 may include hardware and software the same as or similar to that described above with respect to the server 100 of the financial institution.

The system 100 can enhance and improve the user's travel experience by providing timely, relevant information to the user at various stages in the process of planning, booking and/or sharing a travel itinerary. According to one aspect of the invention, the system 100 can provide information to a customer of a financial institution, such as a credit card holder who is planning a travel itinerary. Although this particular example will be described with respect to a credit card holder, other types of cards or accounts from a financial institution or other sponsor that may be associated with a rewards or loyalty program may be used. Examples include accounts associated with airline frequent flyer programs, hotel reward programs, automobile rental reward programs, retail store reward programs, grocery loyalty programs, consortium programs (e.g., upromise), etc. Other types of accounts and associations may be used as necessary and/or desired.

Although embodiments of the system and method disclosed herein may be in the context of certain providers of goods/services, cardholders, customers, websites, financial instruments, etc., it should be recognized that the invention is not so limited. These references are for exemplary purposes only.

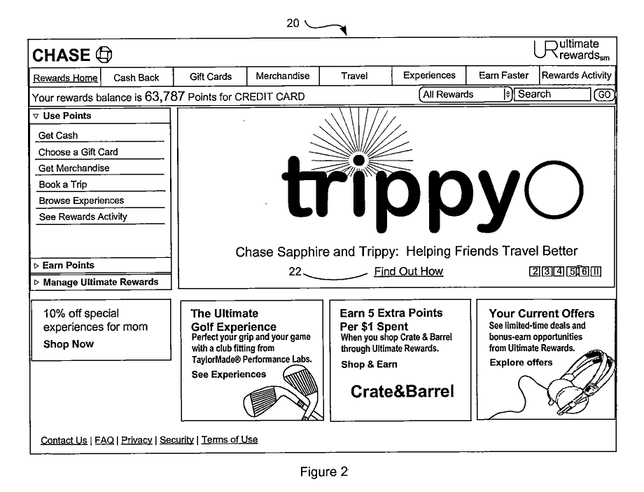

Referring to FIG. 2, initially the cardholder can visit a website 20 of the financial institution, such as a rewards website. For example, the cardholder may visit the Chase Ultimate Rewards™ website. The website provides various information to the cardholder such as information on obtaining cash back, gift cards, merchandise, and travel. The website may also list the current number of points that the cardholder has accumulated, as well as information on using and earning points. The website may also provide information on various retail offers available to the cardholder.

Also shown in FIG. 2 is an example of a link 22 to a travel website. For example, the travel website may be trippy.com. In one embodiment, link 22 invites the cardholder to visit a travel website that has been enhanced with additional features from the financial institution. When the cardholder clicks on the link 22 to the travel website, the travel website sends a web page to the cardholder's communication device (e.g., 140, 150, 160, 170, 180).

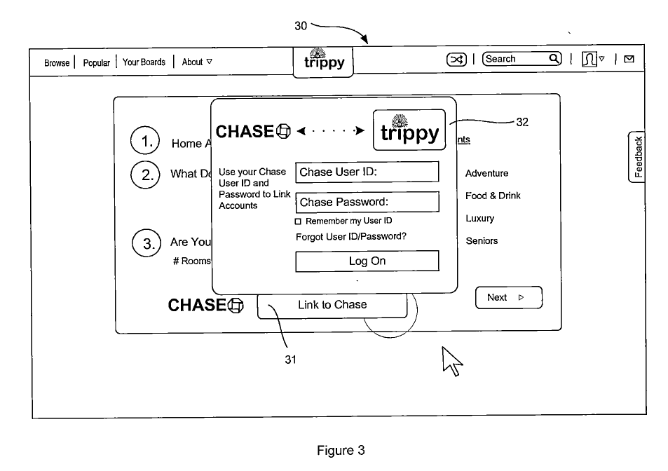

According to an exemplary embodiment of the invention, the travel website is enhanced with features provided by the financial institution. FIG. 3 shows a travel website 30 (e.g., stored and maintained by the travel server 120 in FIG. 1) that includes features from the financial institution, such as a button 31 allowing the cardholder to link to the financial institution system 100 from within the travel website. When the user clicks on the button 31, a pop-up window 32 appears, allowing the user to enter his or her user ID and password from the financial institution and log on to the financial institution system 100. This functionality may be achieved by programming the travel website to generate dynamic web pages using a server side language such as Active Server Pages (ASP), ColdFusion, PHP, or Perl, for example.

In one embodiment, the travel server 120 that administers the travel website 30 may be programmed to call the financial institution server 100 to obtain the necessary content that is used by the travel server 120 to dynamically generate the travel system website 30. Once the cardholder has logged on to the financial institution system 100 through the pop-up window 32 within the travel website 30, the financial institution system 100 can exchange appropriate cardholder information with the travel system 120.

Examples of authentication and transmission of data will discussed below.

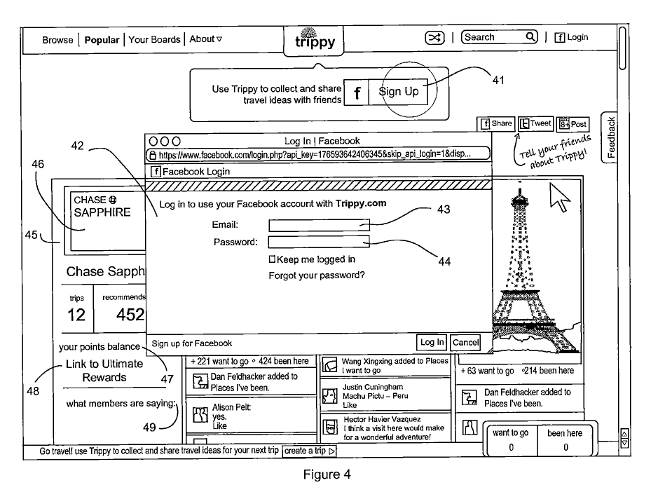

FIG. 4 illustrates another feature of the travel system 120 relating to a social network system 130. As shown in FIG. 4, the travel website may include a button 41 allowing the user to collect and share travel ideas with friends on a social networking site, such as Facebook™, MySpace™, etc. The user may click on the button 41, which generates a pop-up window 42. The pop-up window 42 includes boxes 43, 44 allowing the user to log on to his or her social network account with an email address or user ID (43) and a password (44). This functionality may be achieved by programming the travel website to generate dynamic web pages using a server side language. The travel website may be programmed to call the social network server 130 to obtain the necessary content that is used by the travel server 120 to dynamically generate the travel system website. Once the cardholder has logged into the social network system 130 through the pop-up window 42 within the travel website, the social network system 130 can exchange appropriate user information with the travel system 120.

FIG. 4 also shows an example of a travel website that includes a portion 45 containing content from the financial institution system 100. In this example, the travel website has been dynamically generated using an image 46 of the cardholder's credit card, the points balance 47 from the cardholder's credit card, a link 48 back to the financial institution's reward website, and feedback 49 on various travel itineraries from similarly situated cardholders.

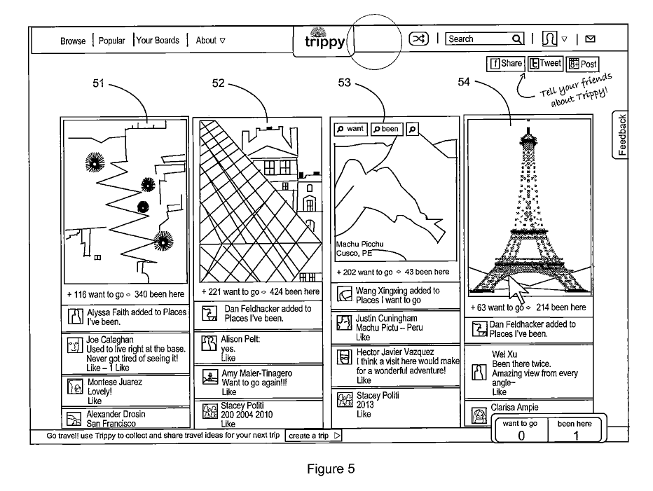

FIG. 5 depicts an example of a web page from the travel website that shows four travel destinations 51, 52, 53, 54 along with commentary and other feedback from various subscribers to the travel website who have been to the travel destinations or who would like to go to the travel destination.

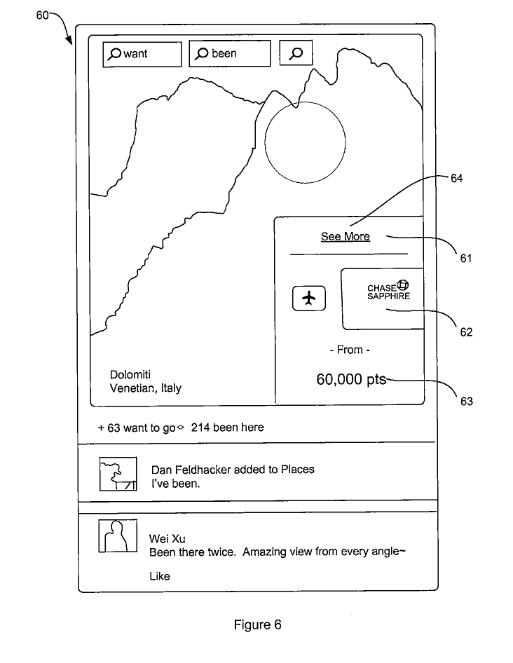

According to an exemplary embodiment of the invention, the user experience in selecting, booking, and/or sharing a travel itinerary is enhanced through the timely provision of relevant information by the financial institution to the user. As shown in FIG. 6, the travel webpage 60 can be dynamically generated to include information to assist a cardholder of the financial institution in using his or her credit card account in planning and booking a travel itinerary. In many instances, a cardholder may not have previously gathered information on his or her points balance and therefore is not in a position to effectively use the rewards offered by the financial institution. Consequently, the financial institution does not obtain a benefit in the form of cardholder loyalty, since the cardholder does not perceive the value of the offered rewards. However, by embedding such information into a dynamically generated travel website, the financial institution is able to educate the cardholder as to available rewards as the cardholder is browsing the travel website and formulating a travel itinerary.

As an example, in FIG. 6 the user can move the pointer over (“mouse over”) the Dolomiti, Italy travel board, which results in a pop-up image 61 being generated that depicts the user's credit card (for example, the Chase Sapphire™ card) and may include a caption 63 regarding using points to pay for airfare or other aspects of the travel itinerary. The pop-up image 61 also includes a link (in this example entitled “See More”) 64 informing the user that additional information on available rewards can be obtained by clicking the link 64. The pop-up feature therefore can provide immediate, relevant information to a cardholder on rewards that are available as they plan their travel itinerary.

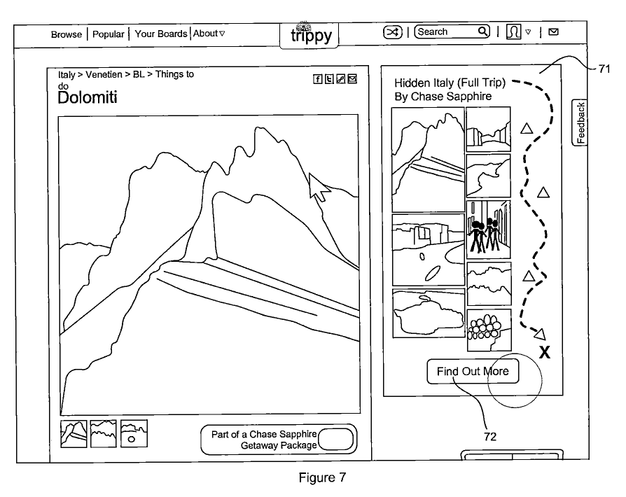

If the cardholder decides to further explore a particular travel destination, he or she may click on the image 61. In this example, the cardholder clicks on the image 61, and the travel system 120 responds by sending another webpage with additional information, as shown in FIG. 7. This web page includes content from the financial institution in the form of an itinerary designed and/or approved by the financial institution. In FIG. 7, a window 71 is presented that informs the cardholder that an itinerary designed and/or approved by the financial institution is available for viewing. The window includes a button 72 entitled “Find Out More” inviting the cardholder to request additional details.

According to one embodiment of the invention, the financial institution can provide enhanced value to the cardholder by customizing the recommended travel itinerary based on data from other similarly situated customers, such as customers who hold a certain type of credit card account with the financial institution. According to one example, the financial institution provides recommendations as to travel destinations, hotels, restaurants, attractions, events, and other elements of a travel itinerary based on data from its other similarly situated cardholders. The data used to formulate the recommendations may be restricted to those cardholders of a certain type of card. For example, the recommendations may be restricted to cardholders of the Chase Sapphire™ card. As a general proposition, each type of credit card offered by a financial institution may appeal to a certain group of people having common interests or characteristics. By formulating the recommendations based on the characteristics, preferences and prior activities of a group people possessing a particular credit card, the financial institution can provide valuable insight and information to a similarly situated cardholder who is planning or booking a travel itinerary. This information can significantly improve the suitability to the cardholder of various aspects of the travel itinerary, such as hotels, restaurants, events and attractions.

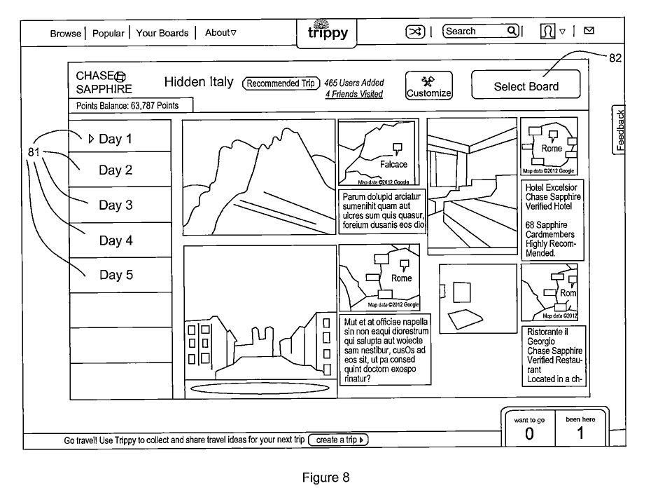

Referring again to FIG. 7, if the cardholder clicks on the button entitled “Find Out More,” the travel website provides a more detailed recommendation as to a travel itinerary, as shown in FIG. 8. FIG. 8 provides an example of an itinerary that includes recommended travel destinations, hotels, and restaurants for each day of a 5-day trip. The cardholder can view the recommendations for each day by clicking on the appropriate day 81. For day 1 in this example, the financial institution has provided recommendations as to a hotel (Hotel Excelsior) and a restaurant (Ristorante il Georgio). These recommendations are based, at least in part, on data from certain cardholders. For example, the data may be based on data from cardholders of the Chase Sapphire™ cardholders. Such data may include, for example, information on prior transactions, prior travel itineraries, personal recommendations of such cardholders, etc. The financial institution is able to provide relevant information to the cardholder as to recommendations for the travel itinerary by using data from similarly situated cardholders of a particular type of card. This cardholder data is not generally available to travel websites, and it can significantly improve a travel itinerary by recommending those locations that have been recommended by similarly situated cardholders of a certain type of card.

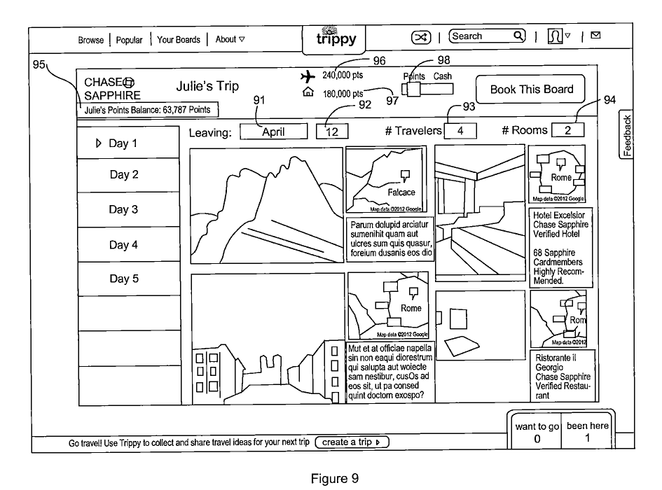

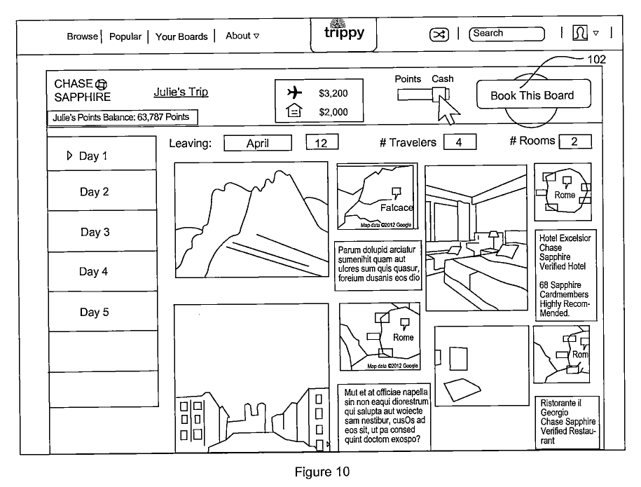

As shown in FIG. 8, the web page includes a button 82 entitled “Select Board,” which allows the cardholder to select the travel board of interest to the cardholder. By selecting the travel board, the cardholder is able to take further steps towards booking the travel itinerary. The next web page presented to the user by the travel system 120 is shown in FIG. 9. FIG. 9 illustrates features that allow the cardholder to refine the itinerary with respect to dates, accommodations, restaurants, travelers, and payment method, for example. The web page in FIG. 9 includes boxes 91, 92, 93, 94 that allow the user to specify the month and date of travel, the number of travelers, and the number of rooms needed. As in previous Figures, the web page presents the cardholder with a display 95 of the number of points he or she has available for use to pay for the travel itinerary. It also provides information to the cardholder as to how many points are needed to pay for the airfare (96) and how many points are need to pay for the hotel (97). A sliding button 98 allows the user to specify what percentage of the cost will be paid for by points and what percentage will be paid for by cash. The user can drag the sliding button 98 with a mouse or other input mechanism to change the proportion. In FIG. 9, the website shows how many points are required to pay for the travel itinerary entirely in points (e.g., 240,000 for air fare, 180,000 points for hotels). In FIG. 10, the web page shows the cost of the itinerary entirely in cash (e.g., $3,200 in air fare, $2,000 in hotels). FIG. 10 also includes a button 102 entitled “Book This Board” inviting the cardholder to book the travel itinerary online.

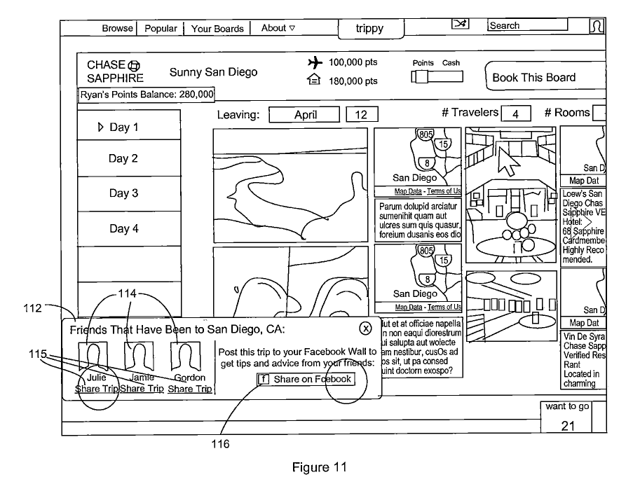

According to another embodiment of the invention, the travel system 120 can be linked with a social network system 130 to enable additional information to be provided to the user with respect to the travel itinerary. As shown in FIG. 11, after the cardholder has selected a destination, in this example San Diego, the travel website generates a pop-up window 112 that presents the cardholder with a list of friends 114 from a social network that have been to that destination. The pop-up window 112 has buttons 115, 116 to enable the user to share the itinerary with one or more of those friends, and/or to place the itinerary on the social network site (e.g., Facebook wall). In either case, the objective is to solicit information from one or more social network friends about the proposed itinerary, including suggestions as to what is recommended and what is not recommended.

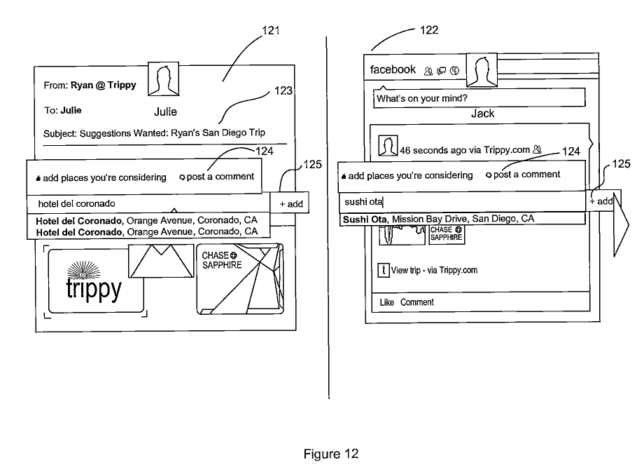

When the user clicks on the “Share Trip” button 115 or the “Share on Facebook” button 116, a message is generated and sent to the friend or posted on the user's Facebook wall. FIG. 12 shows examples of messages 121, 122 received by a friend of the user. In this example, Ryan has clicked on the “Share Trip” button 115 or the “Share on Facebook” button 116, and Julie and Jack receive the messages 121, 122 shown in FIG. 12. The message 121 includes a header 123 asking for suggestions as to the cardholder's itinerary. The messages 121, 122 also include button 124 to allow the recipient friend to post a comment. In this example, by entering the recommendation and clicking the “+add” button 125, Julie identifies Hotel del Coronado as a recommended hotel, and Jack identifies Sushi Ota as a recommended restaurant. The social network friends may also provide additional commentary as to why they recommend the hotel, restaurant or other recommendation for the itinerary.

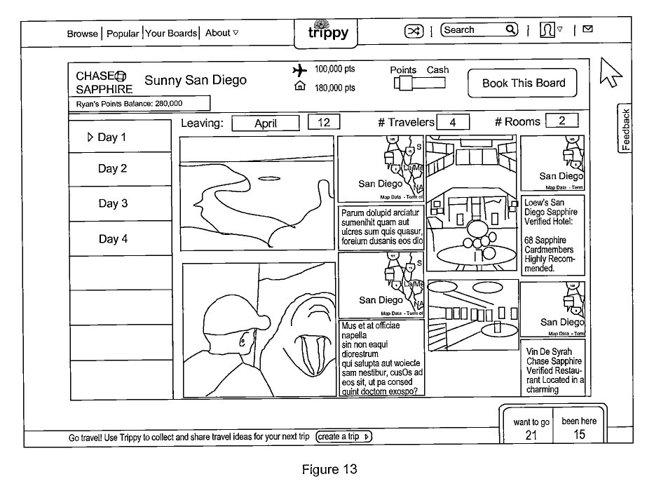

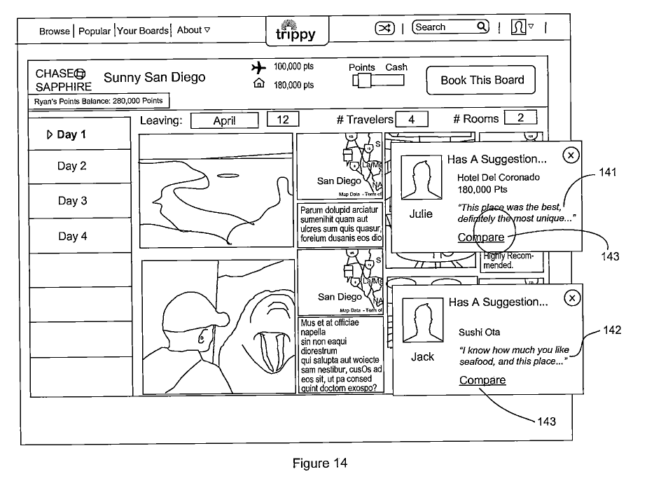

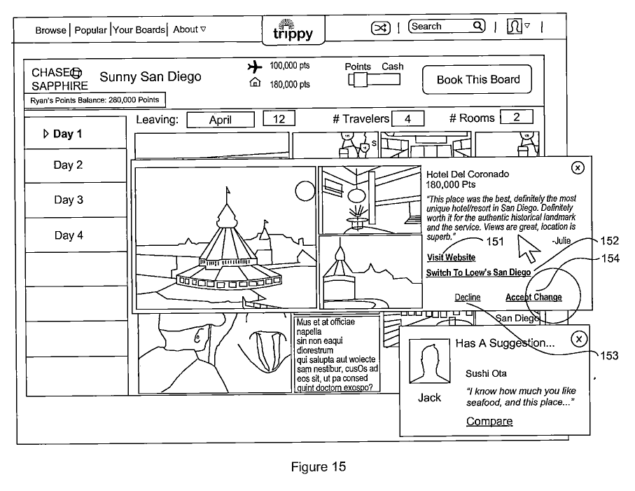

As a result of the friends providing recommendations, the user's travel board on the travel website is modified to show the friends' recommendations. FIG. 13 shows the original itinerary, including an identification of Lowe's San Diego as the hotel and Vin De Syrah as the restaurant. FIG. 14 shows the travel board updated with the friends' suggestions over the original hotel and restaurant. In this example, Julie has recommended Hotel Del Coronado and provided a comment 141, i.e., “This place was the best, definitely the most unique . . . ” and Jack has recommended Sushi Ota and provided a comment 142, i.e., “I know how much you like seafood, and this place . . . .” The linking of the travel system 120 to the social network system 130 can thus enable the user to easily solicit valuable and relevant information from friends to enhance their travel experience. Also shown in FIG. 14 is a “Compare” button 143 which allows the user to obtain more information about the friend's recommendation. When the user clicks on the “Compare” button 143, the travel system 120 provides additional information on the recommendation. As shown in FIG. 15, the travel board now has a link 151 to the recommended hotel (“Visit Website”), a link 152 to switch back to the original hotel (Lowe's San Diego), a “Decline” button 153, and an “Accept Change” button 154. Thus, the travel system 120 allows the user to easily compare hotels by providing links to each website, and allows the user to easily switch choices with the “Decline” and “Accept Change” buttons. The same functionality is available for restaurants and other elements of the travel itinerary. Thus, after the user selects their initial itinerary, and shares it with social network friends, the user can improve it by reviewing suggestions by friends and changing one or more elements of the itinerary.

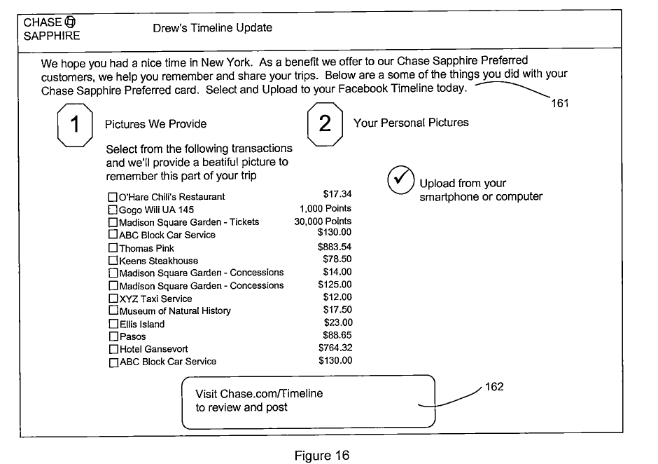

According to another embodiment of the invention, the financial institution system can provide assistance to the user in posting pictures from the travel itinerary to a social network website. After the travel is concluded, the financial institution system 100 will typically have a record of transactions that were conducted during the trip using the credit card. As one example, FIG. 16 shows a list of transactions that were executed with merchants in a trip from Chicago to New York, including O'Hare's Chili's Restaurant, Gogo Wifi UA 145, Madison Square Garden tickets, ABC Black Car Service, Thomas Park, Keen's Steakhouse, Madison Square Garden concessions, Madison Square Garden merchandise, XYZ Taxi Service, Museum of Natural History, Ellis Island, Pastis, Hotel Gansevoort, and ABC Black Car Service. According to one embodiment of the invention, the list of transactions is sent to the cardholder in an email message 161 from the financial institution. The email message can also notify the user that the financial institution has a picture corresponding to some or all of the transactions that the user can post to the user's social network site. This feature can make it easier for the user to share the travel experience with social network friends, for example if the user does not have a picture for various parts of the trip. The email message also invites the user to visit the financial institution's website by clicking a button 162 (in this example, the button labeled “Visit Chase.com/Timeline to review and post”) to review the pictures offered by the financial institution and post them to the cardholder's social network site.

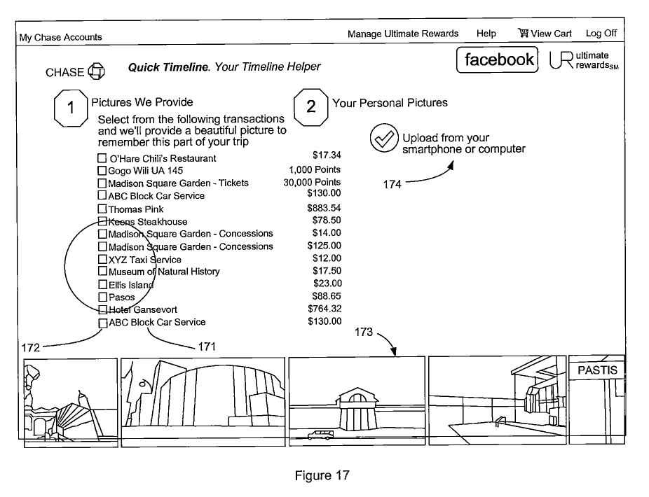

FIG. 17 shows the webpage of the financial institution for selecting pictures corresponding to a particular transaction and for posting them to a social network site. As shown in FIG. 17, each transaction 171 has a corresponding box 172 that can be checked and the pictures 173 for uploading to the social network site are displayed at the bottom of the page. The webpage also includes a button 174 enabling the user to upload his or her own pictures that are stored on the user's phone or computer. In this way, the user can easily select and upload pictures to share with friends showing the trip.

In one embodiment, the user may access pictures and/or videos from security cameras, traffic cameras, or public cameras. The user may also use “following” applications, such as socialcam and vine.

In one embodiment, the photos may be postcards, three dimensional photos, videos, etc.

In one embodiment, geographic metatags, data metatags, etc. that may be associated with the pictures may be used to associate the picture with a location and/or transaction. For example, the financial institution may use metatags and transaction data (e.g., location, time, etc.) to match a particular transaction with a particular picture.

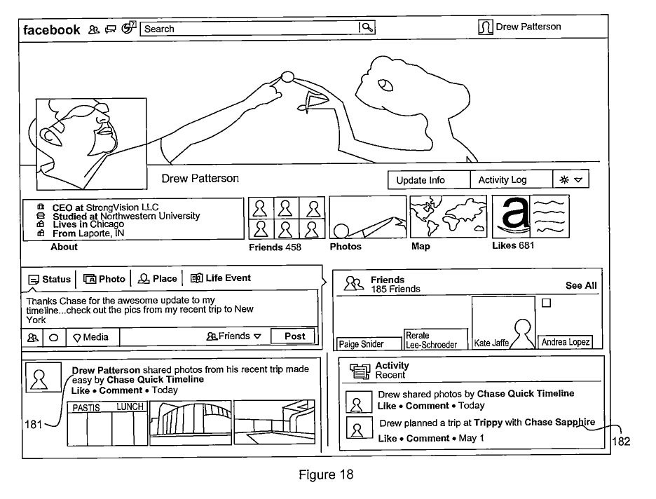

FIG. 18 depicts an example of a web page from the user's social network site that includes the pictures uploaded with the assistance of the financial institution. The caption 181 corresponding to the pictures can acknowledge that the financial institution provided the pictures, which reflects favorably on the financial institution. The social network site can also include a caption 182 indicating that the trip was planned with the travel site (e.g., Trippy) and with the relevant credit card (e.g., Chase Sapphire).

As noted above, certain information may be transmitted from the financial institution, or any other institution that may maintain a rewards or other account for a user, to the third party website. In one embodiment, a high level of security (e.g., full authentication), such as single sign-on with the financial institution, which enables a secure session to be maintained on the third party side for transaction and profile exchanges, may be used. In another embodiment a low level of security (e.g., little or no authentication), which requires no authentication with the financial institution, may be used. In still another embodiment, a medium level of security may be used. Any other level of security may be used as necessary and/or desired.

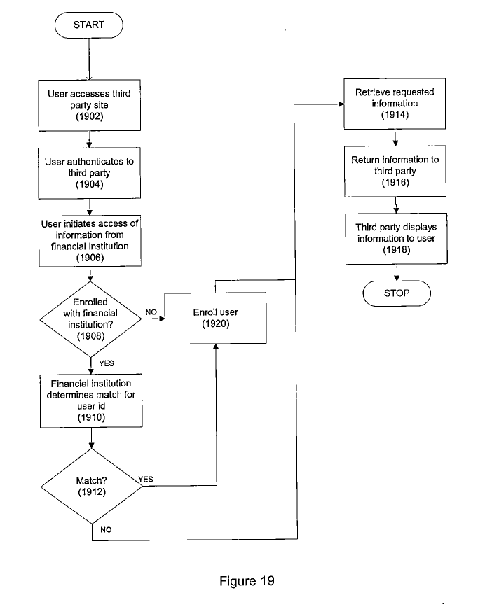

Referring to FIG. 19, a flowchart depicting a method of integration for a third party and, for example, a financial institution, is provided. Although this process is described in the context of a financial institution, it should be noted that the invention is not so limited. Any institution that maintains an account for a user that may contain, for example, rewards, loyalty, etc. points may be accessed as necessary and/or desired.

In one embodiment, the third party site may display some information from the financial institution that is not of a highly-sensitive nature, such as a points balance in a rewards/loyalty account. Other information may be provided as necessary and/or desired.

In step 1902, the user may access or load a third party site. This may be accomplished accessing the third party website with any suitable electronic device, including computers (e.g., desktop, laptop, notebook, tablet, portable, etc.), phones, (e.g., smart phones, mobile phones, etc.), e-reading devices, gaming machines, set top boxes, etc.

In step 1904, the user may authenticate himself or herself to (or logs in to), the third party site by entering his or her third party credentials into a log in screen. In one embodiment, this may involve the user entering his or her third party member identifier, user id, password, PIN number, etc.

In step 1906, the user may initiate the access or load of information from the financial institution. In one embodiment, this may automatically occur after login.

In step 1908, the third party may determine if the member is enrolled with the financial institution. In one embodiment, this may involve determining if the user has provided information on its status with the financial institution. For example, the user may specify the financial institutions with which he or she holds financial accounts, rewards accounts, loyalty accounts, etc.

In one embodiment, the third party may reference a table containing the third party member identifier, user id, etc. and a listing of other institutions with which the user has an account.

If the user is enrolled with the financial institution, in step 1910, the third party accesses the financial institution to determine a match for the third party member identifier, user id, etc. with the financial institution

If the user does not have an account, is not enrolled with, or the third party has no information regarding the user's status with the financial institution, in step 1920, the user may be presented with the option to enroll with the financial institution. This may involve, for example, linking the third party member identifier, user id, etc. to an identifier that is used with the financial institution, receiving authorization from the user to provide the information to the third party, etc. Further, the user may provide some or all of an account number with the financial institution (e.g., the last four digits of a credit card number), the user's surname, the zip code to which statements are mailed, etc. Other information may be provided as necessary and/or desired.

Upon receipt, the financial institution may enroll the user's account so that the information may be provided to the third party.

Once enrolled, the process may continue as described in step 1914.

If a match is determined in step 1912, the information sought, such as a rewards point balance, for the user is retrieved and/or determined in step 1914. This information may be stored by the financial institution itself, or the financial institution may cause retrieval of this information from a vendor, agent, or other party.

The financial institution, in step 1916, returns the information sought to the third party. This may be, for example, in a packet containing the third party member identifier, user id, etc. Other ways of transmitting the requested information to the third party may be used as necessary and/or desired.

In step 1918, the third party may display the information to the user on the third party's sited. In one embodiment, this may be displayed in a pop up window. In still another embodiment, this may be transmitted in a separate communication channel (e.g., email, SMS, etc.).

If, in step 1912, the financial institution cannot determine a match for the third party user identifier, then the user may be presented with the opportunity to enroll with the third party in step 1920. The third party may also be informed of this so it can update its records.

The user may unlink or de-enroll the account so that information is not provided from the financial institution to the third party as necessary and/or desired.

While the foregoing examples may show the various embodiments of the invention (or portions thereof) in one physical configuration, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

Data and information maintained by the servers 100, 120, 130 shown by FIG. 1 may be stored and cataloged in various databases, which may comprise or interface with a searchable database. The databases may comprise, include or interface to a relational database. Other databases, such as a query format database, a Standard Query Language (SQL) format database, a storage area network (SAN), or another similar data storage device, query format, platform or resource may be used. The databases may comprise a single database or a collection of databases, dedicated or otherwise. In some embodiments, the databases may comprise a file management system, program or application for storing and maintaining data and information used or generated by the various features and functions of the systems and methods described herein. In some embodiments, the databases may store, maintain and permit access to customer information, transaction information, account information, and general information used to process transactions as described herein.

Communications network, e.g., 110 in FIG. 1, may be comprised of, or may interface to any one or more of, for example, the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

Communications network, e.g., 110 in FIG. 1, may also comprise, include or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 210 and 212 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, communication network, e.g., 110, may comprise a satellite communications network, such as a direct broadcast communication system (DBS) having the requisite number of dishes, satellites and transmitter/receiver boxes, for example. Communications network, e.g., 110, may also comprise a telephone communications network, such as the Public Switched Telephone Network (PSTN). In another embodiment, communication network 120 may comprise a Personal Branch Exchange (PBX), which may further connect to the PSTN.

Although a number of examples of user communication devices 140, 150, 160, 170, 180 are shown in FIG. 1, exemplary embodiments of the invention may utilize other types of communication devices whereby a user may interact with a network that transmits and delivers data and information used by the various systems and methods described herein. The user communication device may include a microprocessor, a microcontroller or other device operating under programmed control. The user communication device may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. The user communication device may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). The user communication device may also include a network-enabled appliance, a browser-equipped or other network-enabled cellular telephone, or another TCP/IP client or other device.

As described above, FIG. 1 includes a number of servers 100, 120, 130 and user communication devices 140, 150, 160, 170, 180, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, or simply software.

It is appreciated that in order to practice the method of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

As described above, a set of instructions is used in the processing of various embodiments of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the communication devices 140, 150, 160, 170, 180. As used herein, a user interface may include any hardware, software, or combination of hardware and software used by the processor that allows a user to interact with the processor of the communication device. A user interface may be in the form of a dialogue screen for example. A user interface may also include any of a mouse, touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface is any device that provides communication between a user and a processor. The information provided by the user to the processor through the user interface may be in the form of a command, a selection of data, or some other input, for example.

As discussed above, a user interface is utilized by the processor that performs a set of instructions such that the processor processes data for a user. The user interface is typically used by the processor for interacting with a user either to convey information or receive information from the user. However, it should be appreciated that in accordance with some embodiments of the invention, it is not necessary that a human user actually interact with a user interface used by the processor. Rather, it is contemplated that the user interface of the invention might interact, i.e., convey and receive information, with another processor, rather than a human user.

Although the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present invention as disclosed herein.

1. A method comprising:
a travel planning system receiving, at a first display window, user login credentials for the travel planning system from a user;
at least one computer processor for the travel planning system authenticating the user to the travel planning system based on the received user login credentials;
the at least one computer processor for the travel planning system generating, using a server-side language, a second display window comprising a dynamic web page comprising a request for an identifier for a financial account-based reward program account that the user has with a financial institution, the user also having a financial transaction account with the financial institution, wherein the second display window is a pop-up window;
the at least one computer processor for the travel planning system receiving, at the second display window, the identifier for the financial account-based reward program account;
the at least one computer processor for the travel planning system executing a program call to a server of the financial institution to request user reward point information for the financial account-based reward program account using the identifier;
the travel planning system receiving the user reward point information from the financial institution;
the travel planning system rendering, on a display, the received user reward point information to the user;
the at least one computer processor for the travel planning system rendering, on the display, a plurality of travel itineraries to the user, each travel itinerary having at least one reward-eligible item;
the at least one computer processor for the travel planning system embedding rewards information comprising a rewards point requirement to each reward-eligible item; and
the at least one computer processor at the travel planning system rendering, on the display and in a third display window, the embedded rewards information for the reward-eligible item when the user moves a pointer to the reward-eligible item;
wherein the financial institution and the travel planning system are separate entities.

2. The method of claim 1, further comprising:
the at least one computer processor for the travel planning system customizing at least one of the travel itineraries based on data from other customers that have an account with the financial institution.

3. The method of claim 1, further comprising:
the at least one computer processor at the travel planning system rendering, on the display, an indication that at least one of the travel itineraries is recommended by the financial institution.

4. The method of claim 1, further comprising:
the at least one computer processor at the travel planning system rendering, on the display, an indication that at least one of the reward-eligible items on one of the travel itineraries is recommended by the financial institution.

5. The method of claim 1, further comprising:
the at least one computer processor at the travel planning system rendering, on the display, a selector that allows the user to select a payment comprising cash or points or a combination of cash and points to purchase at least one item on the travel itinerary.

6. The method of claim 1, further comprising:
the travel planning system receiving web page content from a social network system, wherein the web page content comprises a login screen for the social network system; and
the travel planning system receiving information from the social network system indicating whether the user has provided valid login credentials.

7. The method of claim 6, further comprising:
the travel planning system receiving from the social network system an identity of at least one friend of the user who has previously traveled to a destination of an itinerary selected by the user;
the at least one computer processor at the travel planning system rendering, on the display, an identification of the at least one friend and a link allowing the user to solicit information from the at least one friend regarding the travel itinerary.

8. A method comprising:
at least one computer processor at a financial institution receiving a program call from a travel planning system for user reward point information for a user, wherein the user reward point information comprises a number of points accumulated by the user and a number of points cost for at least one item of a travel itinerary;
the at least one computer processor at the financial institution system providing, in a pop-up window for a travel planning system, web page content generated by the travel planning system using a server-side language comprising a login screen for the financial institution to the travel planning system;
the at least one computer processor at the financial institution system receiving, at the pop up window, login credentials from the user for a financial account with the financial institution;
the at least one computer processor at the financial institution providing an indication to the travel planning system as to whether the login credentials are valid; and
the at least one computer processor at the financial institution providing user reward point information for a financial account-based reward program account that the user has with the financial institution to the travel planning system;
wherein the financial institution and the travel planning system are separate entities.

9. (canceled)

10. The method of claim 8, further comprising:
the at least one computer processor at the financial institution providing to the travel planning system a recommendation for the user as to one or more reward-eligible items on the travel itinerary, wherein the recommendation is based on data from other cardholders having a credit card of the same type from the financial institution.

11. The method of claim 8, further comprising:
the at least one computer processor at the financial institution sending a message to the user that includes a list of completed credit card transactions associated with the itinerary and offering to provide images associated with at least one of the transactions;
the at least one computer processor at the financial institution receiving from the user an indication as to which of the images are desired;
the at least one computer processor at the financial institution sending to a social network system the images selected by the user for posting.

12. (canceled)

13. (canceled)

14. (canceled)

15. (canceled)

16. (canceled)

17. (canceled)

18. (canceled)

19. The method of claim 1, wherein the second display window comprises a login screen for the financial institution.

20. The method of claim 1, wherein the step of the travel planning system requesting user reward point information for the financial account-based reward program account using the identifier comprises:
the travel planning system establishing a secure session with the financial institution over a computer network.

21. (canceled)

22. The method of claim 1, wherein the server-side language comprises at least one of Active Server Pages, ColdFusion, PHP, and Perl.

23. The method of claim 8, wherein the server-side language comprises at least one of Active Server Pages, ColdFusion, PHP, and Perl.
